(19) United States
(12) Patent Application Publication
(10) Pub. No.: US 2009/0157864 A1
(43) Pub. Date: Jun. 18, 2009

(54) GRID COMPUTING CONTROL METHOD FOR TESTING APPLICATION PROGRAM CAPACITY OF SERVER AND SERVICE METHOD THEREOF

(75) Inventor: Kye-Kwan Kim, Daejeon (KR)

Correspondence Address: GREENBLUM & BERNSTEIN, P.L.C., 1950 ROLAND CLARKE PLACE, RESTON, VA, 20191, US

(73) Assignee: GRIDONE, CO. LTD, Daejeon (KR)

(21) Appl. No.: 11/718,069

(22) PCT Filed: Nov. 28, 2006
(86) PCT No.: PCT/KR06/05049

§ 371 Date: Apr. 26, 2007

(30) Foreign Application Priority Data
Nov. 29, 2005 (KR) 10-2005-0114921

(51) Int. Cl. G06F 15/173

(52) U.S. Cl. 709/224

(57) ABSTRACT

Disclosed is a grid computing control method for testing the application program capacity of a server and a method for providing a service based on the same. The grid computing control method includes the steps of providing a number of user clients with a capacity measurement program by a capacity measurement server; selecting user clients capable of capacity measurement from the user clients, the capacity measurement program having been installed in the user clients, by the capacity measurement server; transmitting a capacity measurement script to the selected user clients by the capacity measurement server; executing the capacity measurement script so as to create capacity measurement data by the selected user clients; transmitting the created capacity measurement data to the capacity measurement server by the selected user clients; and collecting the transmitted capacity measurement data and composing a capacity measurement result report by the capacity measurement server.

### TECHNICAL FIELD

The present invention relates to a grid computing control method for testing the application program capacity of a server and a method for providing a service based on the same. More particularly, the present invention relates to a grid computing control method for testing the application program capacity of a server and a method for providing a service based on the same, wherein, in order to test the application program capacity of a server, a number of clients, which are connected to an application server (test target) via Internet based on grid technology, generate loads so as to analyze the application program of the server.

### BACKGROUND ART

FIG. 1 shows the construction of a conventional computing system for providing an Internet service. The system includes routers 20, a gateway 30, and an application server 40 and provides user clients 10 with a service via Internet. Such a type of computing systems have been developed and used extensively, and the system quality is now an important issue. Therefore, efforts to improve the quality are supported by various authentication institutes and test centers on a national basis.

The conventional system has a problem in that, since a single client is used, the number of processes and threads the operating system can create is limited. This means that the creation of virtual users is restricted. Furthermore, it is difficult to measure the actual capacity based on loads regarding those who have logged in during actual operation, as well as on the network condition of respective regions, because the system depends on the scheduling of processes and threads of the operating system.

### DISCLOSURE OF INVENTION

### Technical Problem

Therefore, the present invention has been made in view of the above-mentioned problems, and it is an object of the present invention to provide a grid computing control method for testing the application program capacity of a server and a method for providing a service based on the same, wherein loads are created as requests expected from actual users and are used for the test so as to guarantee the stability of a developed system by anticipating problems which are likely to occur when the system is operated.

It is another object of the present invention to provide a grid computing control method for testing the application program capacity of a server and a method for providing a service based on the same, wherein clients are adapted to measure the capacity when idle so that the clients owners are provided with economic advantages.

### Technical Solution

In order to accomplish these objects, according to an aspect of the present invention, there is provided a grid computing control method for testing a capacity program capacity of a server, the method including the steps of providing a number of user clients with a capacity measurement program by a capacity measurement server; selecting user clients capable of capacity measurement from the user clients, the capacity measurement program having been installed in the user clients, by the capacity measurement server; transmitting a capacity measurement script to the selected user clients by the capacity measurement server; executing the capacity measurement script so as to create capacity measurement data by the selected user clients; transmitting the created capacity measurement data to the capacity measurement server by the selected user clients; and collecting the transmitted capacity measurement data and composing a capacity measurement result report by the capacity measurement server.

In the step of selecting user clients capable of capacity measurement, more user clients are selected than initially determined user clients at least by a predetermined number.

The user clients are PCs or a group of PCs establishing a small-scale network, and the PCs are used for the capacity measurement during an idle period.

The user clients are selected from clients having excellent system specifications, the clients having high-performance CPU and memory and being turned on for a long period of time, or clients making an excellent contribution during test according to test requirements, and the selected clients are used for the capacity measurement during service.

The user clients are selected from PCs, PDAs, mobile telephones, and terminals equipped with an Internet device and a computation device.

In the step of transmitting the capacity measurement script, a scenario regarding access to an operating system and use of an application program of the operating system is contained in the transmitted script.

In the step of transmitting the created capacity measurement data to the capacity measurement server, the capacity measurement server and the user clients exchange the capacity measurement data as messages.

The capacity measurement server and the user clients exchange the capacity measurement data as messages.

The user clients provide the capacity measurement server with the capacity measurement data according to a grid technique.

According to another aspect of the present invention, there is provided a method for providing a grid computing service so as to test an application program capacity of a server, the method including the steps of requesting a capacity measurement server to perform capacity measurement by a corporation client; registering the requested capacity measurement by the capacity measurement server; composing a capacity measurement script and a schedule regarding the registered capacity measurement and transmitting the capacity measurement script and the schedule to the corporation client by the capacity measurement server; creating capacity measurement data by measuring a capacity of an application server as requested according to the capacity measurement script and the schedule by the capacity measurement server; and collecting the capacity measurement data, composing a result report, and transmitting the result report to the corporation client by the capacity measurement server.

The method further includes a step of accessing the application server of the corporation client as requested and performing a test operation by the capacity measurement server after the step of registering the requested capacity measurement.

In the step of registering the requested capacity measurement, the capacity measurement server and the corporate client make electronic payment for the capacity measurement.

In the step of creating capacity measurement data, a cost resulting from creation of the capacity measurement data is charged.

In the step of creating capacity measurement data and the step of collecting the capacity measurement data, the capacity measurement is performed according to a control method including the steps of providing a number of user clients with a capacity measurement program by the capacity measurement server; selecting user clients capable of capacity measurement from the user clients, the capacity measurement program having been installed in the user clients, by the capacity measurement server; transmitting a capacity measurement script to the selected user clients by the capacity measurement server; executing the capacity measurement script so as to create capacity measurement data by the selected user clients; transmitting the created capacity measurement data to the capacity measurement server by the selected user clients; and collecting the transmitted capacity measurement data and composing a capacity measurement result report by the capacity measurement server.

The user clients are PCs or a group of PCs establishing a small-scale network, and the PCs are used for the capacity measurement during an idle period.

### Advantageous Effects

The grid computing control method for testing the application program capacity of a server and a method for providing a service based on the same according to the present invention are advantageous in that, based on an anticipation that many problems will result from actual users requests when a system is finished and initially operated, loads are created as requests expected from the users so as to measure the capacity. This prevents problems from occurring after the system is completed and operated, and reduces the burden of trial and error and related expenditures.

### BRIEF DESCRIPTION OF THE DRAWINGS

The foregoing and other objects, features and advantages of the present invention will become more apparent from the following detailed description when taken in conjunction with the accompanying drawings in which:

FIG. 1 shows the construction of a conventional system for providing an Internet service;

FIG. 2 shows the construction of a grid computing system for testing the application program capacity of a server according to the present invention;

FIG. 3 is a flowchart showing a grid computing control method for testing the application program capacity of a server according to the present invention;

FIG. 4 shows the construction of a system for providing a grid computing service for testing the application program capacity of a server according to the present invention; and

FIG. 5 is a flowchart showing a method for providing a grid computing service for testing the application program capacity of a server according to the present invention.

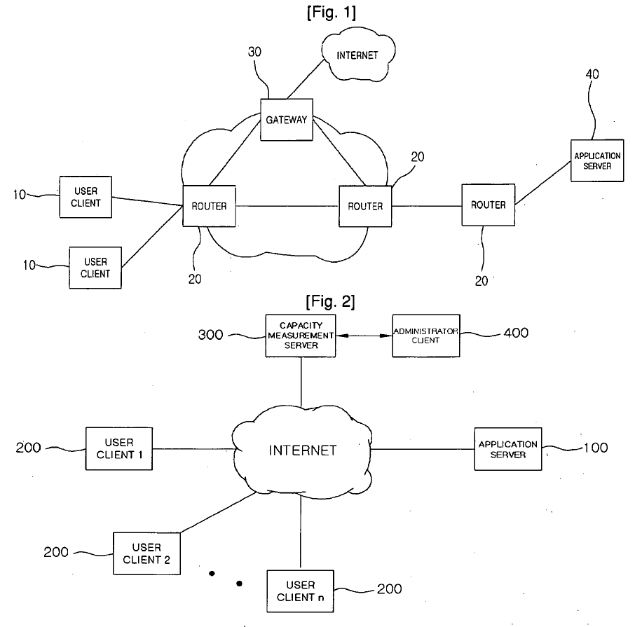

### MODE FOR THE INVENTION

Reference will now be made in detail to the preferred embodiments of the present invention.

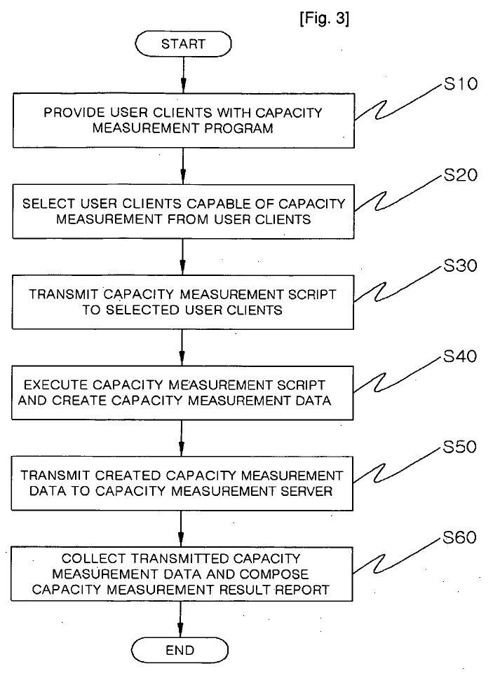

FIG. 2 shows the construction of a grid computing system for testing the application program capacity of a server according to the present invention. The system establishes a network including an application server 100, a number of user clients 200, a capacity measurement server 300, and an administrator client 400. The capacity measurement server 300 collects resources of the user clients 200 and analyzes the capacity of the application server 100.

More particularly, the application server 100 has an application program (i.e. test target) installed therein and provides the user clients 200 with a service based on the application program. The application server 100 receives requests for the service from the user clients 200 according to a procedure and a method specified by a script. As used herein, the script is a kind of load for testing the capacity of the application server 100 and contains a scenario including a log-in step, a step of moving to a bulletin board after the log-in step, and a download step.

The user clients 200 have a capacity measurement program installed therein, which is used to measure the application program capacity of the application server 100. By using the capacity measurement program, the user clients 200 receive a script and a command to execute the script. The capacity measurement program is downloaded from the capacity measurement server 300 to be executed and installed. The command to execute the script is inputted by the administrator server 400, which controls the capacity measurement server 300.

Upon receiving the script, the user clients 200 execute a series of steps according to the scenario contained in the script. Particularly, the user clients 200 log into the application server 100, make use of the bulletin board, and download desired materials. Then, the user clients 200 collect the resulting information regarding the execution.

The user clients 200 may be PCs used by individuals, as well as a group of PCs constituting a small-scale network, most preferably, an Internet cafe'

In summary, each user client 200 accesses the application server 100 and creates data regarding the capacity test. The data is transmitted to the capacity measurement server 300 so that it can measure the capacity of the application server 100.

The capacity measurement server 300 transmits a program, which applies loads to the application server 100 according to a procedure specified by a script, to the user clients 200. The capacity measurement server 300 receives a script execution command, which has been inputted by the administrator server 400, and transmits the command to the user clients 200. The user clients 200 receive the script and communicate with the application program installed in the application server 10 according to the procedure. During this, the user clients 200 collect information regarding the capacity condition of the application program and transmit the information to the capacity measurement server 300, which then analyzes the capacity condition of the application program installed in the application server 100 with reference to the collected data.

When a predetermined number of user clients 200 are necessary to measure the capacity of the application server 100, the capacity measurement server 300 checks whether or not respective clients can perform the test. In addition, the capacity measurement server 300 secures more clients than the predetermined number against a case in which some clients are terminated forcibly during the test.

This process will now be described with reference to an example.

It is assumed that 1,000 user clients are necessary to measure the capacity of the application server 100, and the user clients have a capacity measurement program installed therein. The capacity measurement server 300 selects 1,000 user clients from the user clients 200 that are supposed to participate in the capacity measurement and conducts the test. If the necessary number (1,000) cannot be reached due to abnormal termination of 100 user clients, the application server 100 additionally selects 100 clients so that they participate in the capacity test.

The capacity measurement server 300 conducts communication based on TCP/UDP/IP between the user clients 200. Between the application server 100 and the user clients 200, the capacity measurement server 300 uses a communication mode as required by the application program installed in the application server 100. Particularly, if the application program is a web service program, HTTP is used; if the application program is a database, TCP/IP-based SQL (Structured Query Language) is used; and, if software framework standardization is supported, XML (Extensible Markup Language) is used. In general, Internet-based TCP/UDP/IP communication is basically conducted between the user clients 200 and the application program.

Finally, the capacity measurement server 300 collects data regarding the test of the application server 100 from the user clients 200 and automatically composes a report containing the result of analysis of the capacity measurement. Based on the data from the user clients 200, the report contains items related to the capacity measurement, such as access condition, response time, and download time.

The administrator client 400 provides the capacity measurement server 300 with a script execution command for testing the capacity of the application server 100. The administrator client 400 provides the user clients 200 with a script transmission command for testing the capacity of the application server 100.

The administrator client 400 communicates with the capacity measurement server 300 by using HTTP (Hyper Text Transfer Protocol) or TCP/UDP/IP. The administrator client 400 displays the collection of data regarding the capacity of the application server 100, which has been measured according to the script, from the user clients 200, as well as the report from the capacity measurement server 300.

FIG. 3 is a flowchart showing a grid computing control method for testing the application program capacity of a server according to the present invention. The method includes the following steps:

A capacity measurement server provides a number of user clients with a capacity measurement program (S10); the capacity measurement server selects user clients capable of capacity measurement from the user clients having the capacity measurement program installed therein (S20); the capacity measurement server transmits a capacity measurement script to the selected user clients (S30); the selected user clients execute the capacity measurement script and create capacity measurement data (S40); the selected user clients transmit the created capacity measurement data to the capacity measurement server (S50); and the capacity measurement server collects the transmitted capacity measurement data and composes a report regarding the result of capacity measurement (S60).

During step S10, in which a capacity measurement server provides a number of user clients with a capacity measurement program, the capacity measurement server 300 causes the user clients 200 to download the capacity measurement program, which is used to measure the application program capacity of the application server 100, via Internet and install the program in the user clients 200.

During step S20, in which the capacity measurement server selects user clients capable of capacity measurement from the user clients having the capacity measurement program installed therein, the capacity measurement server 300 selects a number of user clients 200 most suited for capacity measurement. Considering that various situations may occur, e.g. some user clients 200 may not log in, and some user clients 200 may be forcibly terminated during the capacity measurement test, the capacity measurement server 300 selects more user clients 200 than the initially determined number of user clients 200.

In order to specify user clients 200 capable of capacity measurement, the capacity measurement server 300 asks each user client 200 if it can measure the application server 100 at a specific time on a specific date. Based on the response, the capacity measurement server 300 selects user clients 200 suitable for the capacity measurement.

For example, personal clients in an office are idle after the working period (i.e. midnight), and may be used as capacity measurement clients. Clients in an Internet cafe' may be used similarly when there are no customers. Furthermore, among personal clients or clients in an Internet cafe' those having excellent specifications, those turned on for a long period of time, or those making an excellent contribution during test may be selected according to test requirements.

The user clients 200 may be PCs, PDAs, mobile telephones, or terminals equipped with an Internet device and a computation device.

During step S30, in which the capacity measurement server transmits a capacity measurement script to the selected user clients, the capacity measurement server 300 transmits a script regarding a capacity measurement procedure needed by the user clients 200 selected in step S20. As used herein, the script is a kind of load for testing the capacity of the application server 100, and contains a scenario including a log-in step, a step of moving to a bulletin board after the log-in step, and a download step.

During step S40, in which the selected user clients execute the capacity measurement script and create capacity measurement data, the selected user clients 200 receive the capacity measurement script and access the application server 100 by using the script. Then, the selected user clients 200 apply loads to the application server 100 according to the scenario contained in the script so as to create capacity measurement data corresponding to the scenario. The capacity measurement data may be various types of data, including web page movement speed, download rate, and response time.

During step S50, in which the selected user clients transmit the created capacity measurement data to the capacity measurement server, each of the selected user clients 200 transmits various types of capacity measurement data, which has been created according to the script, to the capacity measurement server 300.

The capacity measurement data is exchanged as a message.

During step S60, in which the capacity measurement server collects the transmitted capacity measurement data and composes a report regarding the result of capacity measurement, the capacity measurement server 300 collects capacity measurement data from each of the selected user clients 200 and classifies the collected data for computational and statistical processing. Then, the data is used to compose a report regarding the result of capacity measurement in a predetermined format.

During the above-mentioned steps S10 to S60, the capacity measurement server 300 and the user clients 200 exchange the capacity measurement data as messages. Based on a grid technique, resources of the user clients 200 are shared so as to provide the capacity measurement server 300 with the capacity measurement data.

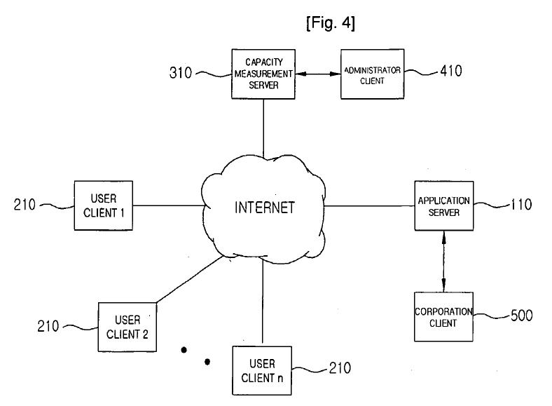

FIG. 4 shows the construction of a system for providing a grid computing service for testing the application program capacity of a server according to the present invention. The system establishes a network including an application server 110, a number of user clients 210, a capacity measurement server 310, an administrator client 410, and a corporation client 500 so as to provide a service of measuring the capacity as requested by the corporation client 500.

The application server 110, the user clients 210, the capacity measurement server 310, and the administrator client 410 function similarly as described with reference to FIG. 2, and repeated description thereof will be omitted herein. The differences will now be described.

Particularly, when the corporation client 500 registers a capacity measurement request, the capacity measurement server 310 settles the charge by using an electronic settlement means. Then, the capacity measurement server 310 pays the cost to the user clients 210, which perform the capacity measurement, by using the electronic settlement means.

As such, the user clients 210 are paid for the capacity measurement by the capacity measurement server 310.

The corporation client 500 accesses a homepage run by the capacity measurement server 310, logs in, and requests capacity measurement by registering the server type, IP, time and date of capacity measurement, and capacity test type. After the registration and test measurement are over, the corporation client 500 downloads a result report from the capacity measurement server 310. During the registration, the corporation client 500 pays the cost to the capacity measurement server 310 by using the electronic settlement means.

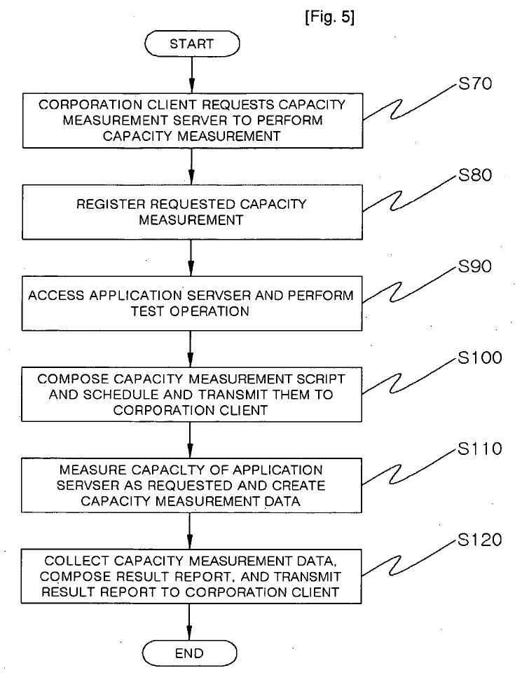

FIG. 5 is a flowchart showing a method for providing a grid computing service for testing the application program capacity of a server according to the present invention. The method includes the following steps:

A corporation client requests a capacity measurement server to measure the capacity (S70); the capacity measurement server registers the requested capacity measurement (S80); the capacity measurement server accesses the application server of the corporation client, which has made the request, and conducts a test operation (S90); the capacity measurement server composes a capacity measurement script and a schedule based on the test operation and transmits them to the corporation client (S100); the capacity measurement server measures the capacity of the application server, the capacity of which is to be measured, according to the script and the schedule so as to create capacity measurement data (S110); and the capacity measurement server collects the capacity measurement data, composes a result report, and transmits the report to the corporation client (S120).

During step S70, in which a corporation client requests a capacity measurement server to measure the capacity, the corporation client 500 logs into a homepage run by the capacity measurement server 310 and requests capacity measurement by entering information including the server type, IP, time and date of capacity measurement, and capacity test type.

During step S80, in which the capacity measurement server registers the requested capacity measurement, the capacity measurement server 310 registers a capacity measurement request in response to the capacity measurement request made in step S70. In addition, the capacity measurement server 310 establishes a transaction with the corporation client 500 by using an electronic settlement means.

During step S90, in which the capacity measurement server accesses the application server of the corporation client, which has made the request, and conducts a test operation, the capacity measurement server 310 accesses a corresponding application server 110 of the corporation client 500 after the capacity measurement registration in step S80. Then, the capacity measurement server 310 performs a test modeling and composes a script containing a scenario regarding the measurement.

During step S100, in which the capacity measurement server composes a capacity measurement script and a schedule based on the test operation and transmits them to the corporation client, the capacity measurement server 310 uses the script composed in step S90 and transmits a capacity measurement schedule regarding the time and date of measurement to the corporation client 500.

Step S110, in which the capacity measurement server measures the capacity of the application server, the capacity of which is to be measured, according to the script and the schedule so as to create capacity measurement data (S110), and step S120, in which the capacity measurement server collects the capacity measurement data, composes a result report, and transmits the report to the corporation client (S120), include the following steps:

Referring to FIG. 3, a capacity measurement server provides a number of user clients with a capacity measurement program (S10); the capacity measurement server selects user clients capable of capacity measurement from the user clients having the capacity measurement program installed therein (S20); the capacity measurement server transmits a capacity measurement script to the selected user clients (S30); the selected user clients execute the capacity measurement script and create capacity measurement data (S40); the selected user clients transmit the created capacity measurement data to the capacity measurement server (S50); and the capacity measurement server collects the transmitted capacity measurement data and composes a report regarding the result of capacity measurement (S60). The report is transmitted to the corporation client 500.

During step S110, in which the capacity measurement server measures the capacity of the application server, the capacity of which is to be measured, according to the script and the schedule so as to create capacity measurement data, the selected user clients 200 request a payment for creation of the capacity measurement data, and the capacity measurement server 310 settles the charge in various manners.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A grid computing control method for testing a capacity program capacity of a server, the method comprising the steps of:
providing a number of user clients with a capacity measurement program by a capacity measurement server;
selecting user clients capable of capacity measurement from the user clients, the capacity measurement program having been installed in the user clients, by the capacity measurement server;
transmitting a capacity measurement script to the selected user clients by the capacity measurement server;
executing the capacity measurement script so as to create capacity measurement data by the selected user clients;
transmitting the created capacity measurement data to the capacity measurement server by the selected user clients; and
collecting the transmitted capacity measurement data and composing a capacity measurement result report by the capacity measurement server.

2. The method as claimed in claim 1, wherein, in the step of selecting user clients capable of capacity measurement, more user clients are selected than initially determined user clients at least by a predetermined number.

3. The method as claimed in claim 2, wherein the user clients are PCs or a group of PCs establishing a small-scale network, and the PCs are used for the capacity measurement during an idle period.

4. The method as claimed in claim 2, wherein the user clients are selected from clients having excellent system specifications, the clients having high-performance CPU and memory and being turned on for a long period of time, or clients making an excellent contribution during test according to test requirements, and the selected clients are used for the capacity measurement during service.

5. The method as claimed in claim 3, wherein the user clients are selected from PCs, PDAs, mobile telephones, and terminals equipped with an Internet device and a computation device.

6. The method as claimed in claim 1, wherein, in the step of transmitting the capacity measurement script, a scenario regarding access to an operating system and use of an application program of the operating system is contained in the transmitted script.

7. The method as claimed in claim 1, wherein, in the step of transmitting the created capacity measurement data to the capacity measurement server, the capacity measurement server and the user clients exchange the capacity measurement data as messages.

8. The method as claimed in claim 6, wherein the capacity measurement server and the user clients exchange the capacity measurement data as messages.

9. The method as claimed in claim 6, wherein the user clients provide the capacity measurement server with the capacity measurement data according to a grid technique.

10. A method for providing a grid computing service so as to test an application program capacity of a server, the method comprising the steps of:
requesting a capacity measurement server to perform capacity measurement by a corporation client;
registering the requested capacity measurement by the capacity measurement server;
composing a capacity measurement script and a schedule regarding the registered capacity measurement and transmitting the capacity measurement script and the schedule to the corporation client by the capacity measurement server;
creating capacity measurement data by measuring a capacity of an application server as requested according to the capacity measurement script and the schedule by the capacity measurement server; and
collecting the capacity measurement data, composing a result report, and transmitting the result report to the corporation client by the capacity measurement server.

11. The method as claimed in claim 10, further comprising a step of accessing the application server of the corporation client as requested and performing a test operation by the capacity measurement server after the step of registering the requested capacity measurement.

12. The method as claimed in claim 10, wherein, in the step of registering the requested capacity measurement, the capacity measurement server and the corporate client make electronic payment for the capacity measurement.

13. The method as claimed in claim 10, wherein, in the step of creating capacity measurement data, a cost resulting from creation of the capacity measurement data is charged.

14. The method as claimed in claim 10, wherein, in the step of creating capacity measurement data and the step of collecting the capacity measurement data, the capacity measurement is performed according to a control method comprising the steps of:
providing a number of user clients with a capacity measurement program by the capacity measurement server;
selecting user clients capable of capacity measurement from the user clients, the capacity measurement program having been installed in the user clients, by the capacity measurement server;
transmitting a capacity measurement script to the selected user clients by the capacity measurement server;
executing the capacity measurement script so as to create capacity measurement data by the selected user clients;
transmitting the created capacity measurement data to the capacity measurement server by the selected user clients; and
collecting the transmitted capacity measurement data and composing a capacity measurement result report by the capacity measurement server.

15. The method as claimed in claim 14, wherein the user clients are PCs or a group of PCs establishing a small-scale network, and the PCs are used for the capacity measurement during an idle period.
